(19) United States
(12) Patent Application Publication
(10) Pub. No.: US 2022/0219466 A1
(43) Pub. Date: Jul. 14, 2022

(54) MANUAL MEDIA SHEET INSERTION AT DUPLEX REVERSAL POINT OF DUPLEX PRINTING PATH

(71) Applicant: Hewlett-Packard Development Company, L.P., Spring, TX (US)

(72) Inventors: KOK CHAI CHONG, Singapore (SG); John J. Cantrell, Vancouver, WA (US); Suriyaprakash Saravanan, Singapore (SG); Seng San Koh, Singapore (SG)

(73) Assignee: Hewlett-Packard Development Company, L.P., Spring, TX (US)

(21) Appl. No.: 17/614,009

(22) PCT Filed: Sep. 9, 2019
(86) PCT No.: PCT/US2019/050141

§ 371 Date: Nov. 24, 2021

(51) Int. Cl. B41J 13/00

(52) U.S. Cl. CPC B41J 13/0045

(57) ABSTRACT

A media sheet is manually inserted at a duplex reversal point of a duplex printing path of the printing device. The media sheet is advanced through the duplex printing path. As the media sheet advances through the duplex printing path, the media sheet is printed on, and the printed media sheet output from the printing device.

### BACKGROUND

Printing devices can be standalone printers that have just printing functionality, or multifunction peripherals (MFPs), multifunction devices (MFDs), and all-in-one (AIO) printing devices that combine printing functionality with other functionality, such as scanning, copying, and faxing functionality. Printing devices can use a variety of different technologies, including inkjet and laser technologies. Printing devices print using print material, such as colorant like ink or toner, to form images on print media like sheets of paper.

### BRIEF DESCRIPTION OF THE DRAWINGS

FIGS. 1A, 1B, and 1C are diagrams of an example printing device having a C- or U-shaped duplex printing path with a duplex reversal point at which a media sheet can be manually inserted into the printing device.

FIGS. 2A and 2B are diagrams of an example printing device having an S-shaped duplex printing path with a duplex reversal point at which a media sheet can be manually inserted into the printing device.

FIGS. 3A and 3B are diagrams of an example control and a media guide ramp of a printing device to assist with manual media sheet insertion at a duplex reversal point of a duplex printing path of the device.

FIGS. 4A, 4B, and 4C are diagrams of an example control and media sheet edge guides to assist with manual media sheet insertion at a duplex reversal point of a duplex printing path of the device.

FIG. 5 is a flowchart of an example method for printing using a printing device having a duplex printing path with a duplex reversal point at which a media sheet can be manually inserted into the printing device.

FIG. 6 is a diagram of an example computer-readable data storage medium for a printing device having a duplex printing path with a duplex reversal point at which a media sheet can be manually inserted into the printing device.

FIG. 7 is a block diagram of an example printing device having a duplex printing path with a duplex reversal point at which a media sheet can be manually inserted into the printing device.

### DETAILED DESCRIPTION

Printing devices can form images on print media by outputting colorant, such as toner or ink, onto the media. A printing device may be able to print on a variety of different types of print media, such as standard-weight office or copy paper, higher quality and heavier bond paper, inkjet paper that is adapted for inkjet printing, photo paper (including inkjet photo paper) that is adapted for printing photographs, and so on. Even among print media of the same type, like bond paper, there may be different sub-types, such as letterhead bond paper and blank bond paper.

Printing devices can include removable or fixed input trays in which print media is loaded. During printing of the pages of a print job, a printing device may “pick” and print on successive sheets of media from an input tray. One tray of a printing device may be loaded with print media of the type that the device is most often used to print on.

Different printing devices have different approaches for printing on multiple print media types. A printing device may have multiple input trays, such as a higher-capacity tray for loading media of the type that the device is most often used to print on, and a lower-capacity tray for loading media of types that are less frequently printed on, such as photo paper. The lower-capacity tray may in fact be integrated on the higher-capacity tray, for loading just a single media sheet at a time. Adding additional input trays to a printing device can increase manufacture cost, however, even if the trays are integrated with a higher-capacity tray.

Therefore, another approach is for a printing device to simply forego additional input trays. To print on print media of a different type than the media currently loaded in the tray, a user may have to remove the currently loaded media from the tray and replace it with the media of the different type. If the input tray is removable, the user may first have to remove the tray from the printing device before switching the type of media loaded in the tray, and then reinsert the tray into the device.

If the printing device “picks” sheets for printing from the top of the print media stack in the input tray, the user may just add media of a different type if it has a similar size as the type already in the tray. However, the user may still have to remove the tray from the printing device before adding media of the different type. Thus printing on different types of media can be time-consuming and inconvenient.

A printing device may instead have different input trays for different media types. If the printing device's input tray is removable, the user thus removes the installed input tray from the device and in its place inserts the supplemental input tray having media of the different type. When printing on the different media type is finished, the user may then switch back in the original tray. While this process is more convenient than using the same input tray for multiple media types, it is expensive and inconvenient because the user has to acquire and keep track of another input tray.

Described herein are techniques to provide a way by which media sheets can be inserted into a printing device having automatic duplex printing capability, and which ameliorate the above noted and other shortcomings. The automatic duplex printing capability permits the device to print on both sides of a media sheet automatically, without requiring the user to reload the media sheet back into the device after the first side has been printed on so that the device can print on the second side of the sheet. The techniques described herein leverage the duplex printing path of the automatic duplex printing capability to receive manual insertion of a media sheet at a duplex reversal point of the path.

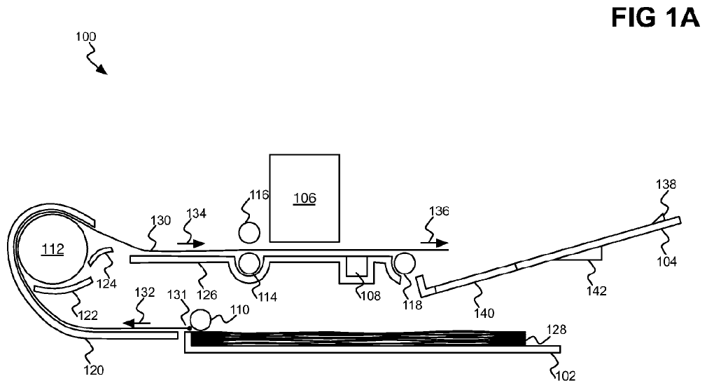

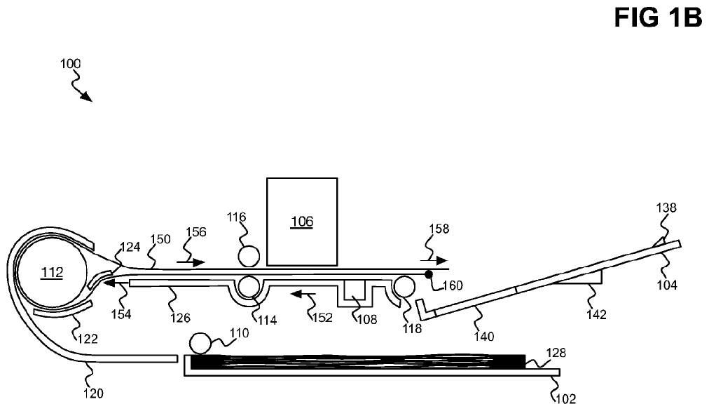

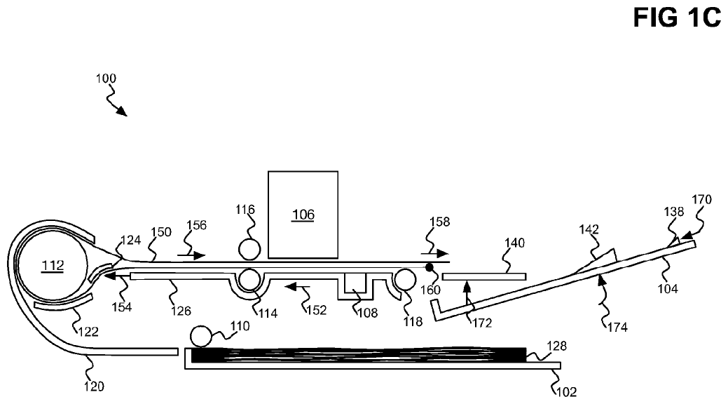

FIGS. 1A, 1B, and 1C show an example printing device 100 having a C- or U-shaped duplex printing path with a duplex reversal point at which a media sheet can be manually inserted into the printing device 100. The printing device 100 can be a standalone printer or a printing device having other functionality in addition to printing functionality. The printing device 100 can be an inkjet-printing device, a laser-printing device, or a printing device that uses another type of printing technology.

As depicted in FIGS. 1A, 1B, and 1C, the printing device 100 can include an input tray 102 for loading media sheets 128 into the device 100. In some examples, there may be one input tray in the printing device 100 (the tray 102), or there may be multiple input trays, including the tray 102. The input tray 102 may be fixed and thus non-removable from the printing device 100, or it may be removably insertable into the device 100. In the latter case, the input tray 102 may be referred to as a cassette.

The printing device 100 can include an output tray 104. The output tray 104 collects media sheets 128 after they have advanced through and output from the device 100. In the techniques described herein, the output tray 104 can also serve as an input tray in a manual insertion mode of the device 100, in which a media sheet is manually inserted at a duplex reversal point of a duplex printing path of the device 100.

The printing device 100 can include a print engine 106 that ejects colorant, like ink or toner, as the media sheets 128 advance past and incident to the engine 106 through the device 100. The print engine 106 may be an inkjet-printing engine that jets ink, a laser-printing eject that outputs toner, or a different type of print engine using a different type of colorant, to form images on the media. The print engine 106 may be a monochromatic print engine that can print in just one color, such as black to form black-and-white images, or may be a color printing engine that can print in multiple colors to form full-color images.

The printing device 100 may include a media sensor 108. The media sensor 108 can detect presence (and thus absence as well) of the media sheets 128 as they advance past and incident to the sensor 108. The printing device 100 can include rollers 110, 112, 114, 116, and 118. At least the rollers 114, 116, and 118 are reversibly rotatable, being able to rotate both clockwise and counter-clockwise. The rollers 110, 112, 114, 116, and 118 advance the media sheets 128 through the device 100 along various paths. Although five such rollers 110, 112, 114, 116, and 118 are depicted in FIGS. 1A, 1B, and 1C, the device 100 may have more or fewer such rollers.

The printing device 100 can include media guides 122 and 124, which guide the media sheets 128 along various paths as the sheet 128 advances through the device 100. Although two such guides 122 and 124 are depicted in FIGS. 1A, 1B, and 1C, the device 100 may have more or fewer such guides. The device 100 can include other components as well, in addition to and/or in lieu of those depicted in FIGS. 1A, 1B, and 1C.

FIG. 1A shows a simplex printing path 130 of the printing device 100. The simplex printing path 130 is the path beginning at a simplex entry point 131 and along which media sheets 128 advance from the input tray 102 and past the print engine 106. When the media sheets 128 advance past the print engine 106, the engine 106 can print on the sides of the sheets 128 that face the engine 106. These sides of the sheets 128 are the sides that face down in the input tray 102.

To advance a media sheet 128 along the simplex printing path 130, the roller 110, which can be referred to as a pick roller, “picks” or advances the top-most sheet 128 from the stack of sheets loaded in the input tray 102 by rotating clockwise, and advances the sheet 128 in the direction indicated by the arrow 132, towards the roller 112. The guide 120 guides the media sheet 128 toward the roller 112. As the roller 112 engages and advances the sheet 128 by rotating clockwise, the guide 120 guides the media sheet 128 in the direction indicated by the arrow 134, towards the guide 126.

The guide 126 guides the media sheet 128 in the direction indicated by the arrow 134, towards the rollers 114 and 116. The rollers 114 and 116 engage and advance the sheet 128 by respectively rotating clockwise and counter-clockwise. The media sheet 128 advances between the rollers 114 and 116, still in the direction indicated by the arrow 134, past the print engine 106 and then past the media sensor 108 towards the roller 118. As the sheet 128 advances past the print engine 106, the engine 106 can output colorant onto the media sheet 128. The roller 118, rotating clockwise, engages and advances the sheet 128 outward from the print engine 106, in the direction indicated by the arrow 136. The media sensor 108 detects that the sheet 128 has reached the end of the simplex printing path 130.

In a simplex mode of the printing device 100, the roller 118 outputs the media sheet 128 onto the output tray 104. Specifically, the roller 118 advances the sheet 128 until it no longer engages the media sheet 128, ejecting the sheet 128 from the simplex printing path 130 of the device 100 onto the tray 104. In the simplex mode, the printing device 100 thus prints on one side of the media sheet 128 as the sheet 128 advances from the input tray 102 through the simplex printing path 130, specifically the side facing down when the sheet 128 is in the tray 102.

FIG. 1B shows a duplex printing path 150 of the printing device 100. The duplex printing path 150 is the path along which media sheets 128 advance from a duplex reversal point 160 at the beginning of the path 150. The media sheets 128 are flipped over along the duplex printing path 150, so that the print engine 106 can print on the sides of the sheets 128 opposite to the sides that face the engine 106 when initially advancing along the path 150.

In a duplex mode of the device 100, the roller 118 reversibly draws a media sheet 128 back into the printing device 100 after the sheet 128 has advanced through the simplex printing path 130 of FIG. 1A. Instead of outputting the sheet 128 onto the output tray 104 as in the simplex mode, the roller 118 switches rotational direction. The duplex reversal point 160 is thus the point at which the media sheet 128 is drawn back into the printing device 100 for advancement through the duplex printing path 150 for second-side printing, after the sheet 128 has been first-side printed during advancement through the simplex printing path 130.

The roller 118, rotating counter-clockwise, advances the media sheet 128 in the direction indicated by the arrow 152, past the media sensor 108 and the print engine 106 and toward the rollers 114 and 116. The media sensor 108 can detect when the sheet 128 has been completely reversed drawn back into the printing device 100 in the duplex mode. The rollers 114 and 116 engage and advance the media sheet 128, by respectively rotating counter-clockwise and clockwise, toward the guide 124 as indicated by the arrow 154. The guide 124 guides the sheet 128 towards the guide 122, which guides the media sheet 128 towards the roller 112. As the roller 112 engages and advances the sheet 128 by rotating clockwise, the guide 120 guides the media sheet 128 in the direction indicated by the arrow 156, towards the guide 126.

At this point, the duplex printing path 150 becomes the same as the simplex printing path 130 of FIG. 1A. The guide 126 guides the media sheet 128 in the direction indicated by the arrow 156, towards the rollers 114 and 116. The rollers 114 and 116 reverse rotational direction again, engaging and advancing the sheet 128 by respectively rotating clockwise and counter-clockwise.

The media sheet 128 advances between the rollers 114 and 116, still in the direction indicated by the arrow 156, past the print engine 106 and then past the media sensor 108, towards the roller 118. As the sheet 128 advances past the engine 106, the print engine 106 can output colorant onto the media sheet 128. The roller 118 reverses rotational direction again, rotating clockwise, to engage and advance the sheet 128 outward from the print engine 106 until the roller 118 has output the media sheet 128 onto the output tray 104 and thus no longer engages the sheet 128. The media sensor 108 detects that the sheet 128 has reached the end of the duplex printing path 150.

In the duplex mode, the device 100 thus first prints print on one side of the media sheet 128 as it advances from the input tray 102 through the simplex printing path 130 of FIG. 1A, specifically the side facing down when the sheet 128 is in the tray 102. Rather than outputting the sheet 128 onto the output tray 104 as in the simplex mode, the device 100 in the duplex mode then reversibly draws the sheet 128 back in at the duplex reversal point 160. The printing device 100 flips the media sheet 128 over as the sheet 128 advances through the duplex printing path 150, so that the device 100 can print on the other side of the media sheet 128 before outputting it onto the output tray 104.

The duplex mode is an automatic duplex mode. This means that the printing device 100 can automatically reversibly draw the media sheet 128 back in for printing on the second side of the sheet 128 after the first side of the sheet 128 has been printed. The user does not have to manually insert the media sheet 128 back into the device 100, or otherwise handle the sheet 128, for second-side printing after first-side printing of the media sheet 128.

The printing device 100 can include a control 138, a media sheet guide ramp 140, and media sheet edge guides 142. An example implementation of the control 138, guide ramp 140, and edge guides 142 is presented later in the detailed description. The control 138 can be a button that is switchably positionable between a pulled-out position in FIGS. 1A and 1B and a pushed-in position in FIG. 1C. When the control 138 is in the pulled-out position, a user can push the control 138 inwards to the pushed-in position, per the arrow 170 of FIG. 1C, and then pull the control 138 outwards back to the pulled-out position.

The media sheet guide ramp 140 is switchably positionable between an unused, recessed position in FIGS. 1A and 1B and a used, extended position in FIG. 1C. When the control 138 is in the pulled-out position, the guide ramp 140 is in the recessed position. Pushing the control 138 inwards to the pushed-in position can raise the ramp 140 upwards from the recessed position to the extended position, per the arrow 172 of FIG. 1C. In the extended position, the ramp 140 is tangential to the roller 118 at the duplex reversal point 160. Pulling the control 138 outwards back to the pulled-out position can cause the ramp 140 to lower back to the recessed position.

The media sheet edge guides 142 are switchably positionable between an unused, recessed position in FIGS. 1A and 1B and a used, extended position in FIG. 1C. When the control 138 is in the pulled-out position, the edge guides 142 are in the recessed position. Pushing the control 138 inwards to the pushed-in position can rotate the edge guides 142 upward from the recessed position to the extended position, per the arrow 174 of FIG. 1C. Pulling the control 138 outwards back to the pulled-out position can cause the edge guides 142 to rotate back inward to the recessed position.

FIG. 1C shows how the duplex printing path 150 of the printing device 100 can be leveraged in a manual insertion mode to receive manual insertion of a media sheet 128 at the duplex reversal point 160 for simplex-printing the sheet 128 without the media sheet 128 having to advance through the simplex printing path 130. A user may insert a media sheet 128 of a different type into the printing device 100 without having to disturb the stack of media sheets 128 loaded in the input tray 102. In the implementation of FIG. 1C, the output tray 104 also serves as an input tray in the manual insertion mode.

A user positions the media sheet 128 laterally between the media sheet edge guides 142 extending from the output tray 104, and pushes the sheet 128 inwards along the extended media sheet guide ramp 140 towards the roller 118. The edge guides 142 assist lateral positioning of the media sheet 128 during manual insertion of the sheet 128. That is, the guides 142 ensure that the lateral (e.g., side) edges of the media sheet 128 perpendicular to the leading and trailing edges of the sheet 128 are aligned for correct insertion.

The guide ramp 140 guides the media sheet 128 towards the roller 118 during manual insertion of the sheet 128. The roller 118 engages the media sheet 128 as the sheet 128 is manually inserted at the duplex reversal point 160 by rotating counter-clockwise. The media sheet 128 then advances through the duplex printing path 150 as in FIG. 1B, for printing on the side of the sheet 128 facing the ramp 140 during manual insertion of the media sheet 128.

The roller 118 thus advances the manually inserted media sheet 128 in the direction indicated by the arrow 152, past the media sensor 108 and towards the rollers 114 and 116. The sensor 108 can be used in the manual insertion mode to detect the leading and/or lagging edges of the media sheet 128, so that the position of the sheet 128 as it advances through the duplex printing path 150 is known.

The rollers 114 and 116 engage and advance the media sheet 128, by respectively rotating counter-clockwise and clockwise, towards the guide 124, as indicated by the arrow 154. The guide 124 guides the sheet 128 towards the guide 122, which guides the media sheet 128 towards the roller 112. As the roller 112 engages and advances the sheet 128 by rotating clockwise, the guide 120 guides the media sheet in the direction indicated by the arrow 156, towards the guide 126. The guide 126 guides the media sheet 128 towards the rollers 114 and 116, still in the direction indicated by the arrow 156. The rollers 114 and 116 reverse rotational directional, engaging and advancing the sheet 128 by respectively rotating clockwise and counter-clockwise.

The media sheet 128 advances between the rollers 114 and 116, still in the direction indicated by the arrow 156, past the print engine 106 and then past the media sensor 108, towards the roller 118. As the sheet 128 advances past the engine 106, the engine 106 can output colorant onto the media sheet 128. The roller 118 reverses rotational direction, rotating clockwise to engage and advance the sheet 128 outwards from the print engine 106 until the roller 106 has output the media sheet 128 onto the output tray 104 and no longer engages the sheet 128.

The manual insertion mode of the printing device 100 differs from the simplex and duplex modes. In the simplex mode, the device 100 advances a media sheet 128 along the simplex printing path 130 of FIG. 1A from the input tray 102 and outputs the sheet 128 onto the output tray 104 after having printed on the side of the media sheet 128 facing down in the input tray 102. In the duplex mode, the printing device 100 advances a sheet 128 first along the simplex printing path 130 of FIG. 1A as in the simplex mode. Instead of outputting the media sheet 128 onto the output tray 104, however, in the duplex mode the device 100 reversibly draws the sheet 128 back in for printing on the opposite side by advancing the media sheet 128 along the duplex printing path 150 of FIG. 1B.

In the manual insertion mode, the printing device 100 does not reversibly draw a media sheet 128 back into the device 100 for advancement along the duplex printing path 150 of FIG. 1B after the sheet 128 has already advanced along the simplex printing path 130 of FIG. 1A. Rather, the printing device 100 draws in a media sheet 128 manually inserted at the duplex reversal point 160 of the duplex printing path 150 for advancement along the duplex printing path 150 as in FIG. 1C (i.e., without the sheet 128 having first advanced along the simplex printing path 130). The manual insertion mode thus leverages the duplex printing path 150 provided for the duplex mode.

The described techniques provide a manual insertion mode to a printing device, like the printing device 100 of FIGS. 1A-1C, which may otherwise not have one. The techniques achieve this by leveraging the duplex printing path of the printing device. This is why in the manual insertion mode, the media sheet inserted at the duplex reversal point may have to be flipped over prior to simplex-printing, as in FIG. 1C. The printing device may not otherwise be able to receive and subsequently simplex-print the media sheet.

For example, in the printing device 100 of FIGS. 1A-1C, the roller 112 may not be reversibly rotatable, and may just be able to rotate clockwise. Therefore, a media sheet manually inserted at the duplex reversal point 160 has to travel along the duplex printing path 150 and thus has to be flipped over prior to being printed on. As another example, the printing device 100 of FIGS. 1A-1C may not have any way to receive a manually inserted media sheet other than at the duplex reversal point 160.

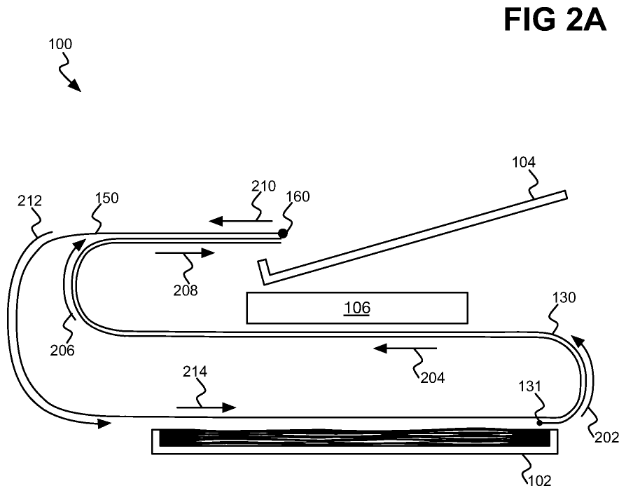

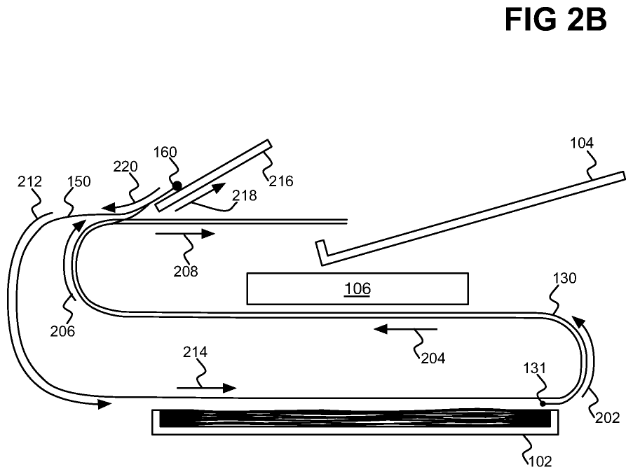

FIGS. 2A and 2B shows an example printing device 100 having an S-shaped duplex printing path with a duplex reversal point at which a media sheet can be manually inserted into the printing device. FIGS. 2A and 2B thus show that a duplex printing path can be leveraged in a manual insertion mode, even if the duplex printing path is S-shaped and not C- or U-shaped as in FIGS. 1A, 1B, and 1C. For descriptive and illustrative clarity and convenience, guides, rollers, and sensors of the printing device 100 are not depicted in FIGS. 2A and 2B.

The printing device 100 of FIGS. 2A and 2B can advance a media sheet 128 beginning at the simplex entry point 131 of the simplex printing path 130. The device 100 thus picks the sheet 128 from the input tray 102, and advanceably flips the media sheet 128 over per the arrow 202. The printing device 100 advances the sheet 128 past the print engine 106, as indicated by the arrow 204. The print engine 106 can print on the side of the media sheet 128 incident to the engine 106 as the sheet 128 advances past. This is the side of the media sheet 128 facing down when the sheet 128 was in the tray 102.

The printing device 100 again advanceably flips the media sheet 128 over, per the arrow 206, and then advances the sheet 128 in the direction indicated by the arrow 208. In the simplex mode, the device 100 outputs the media sheet 128 onto the output tray 104. In the duplex mode, the printing device 100 instead reversibly draws the sheet 128 back in at the duplex reversal point 160 of the duplex printing path 150.

The duplex reversal point 160 is differently located between FIGS. 2A and 2B. In the implementation of FIG. 2A, the duplex reversal point 160 is located at the output tray 104, as in FIGS. 1A, 1B, and 1C. In the duplex mode, the printing device 100 therefore advances the sheet 128 in the direction indicated by the arrow 210 after having drawn the media sheet 128 back in at the duplex reversal point 160.

In the implementation of FIG. 2B, the duplex reversal point 160 is located at a duplex reversal tray 216. In the duplex mode, the printing device 100 first advances the media sheet 128 upward along the duplex reversal tray 216, per the arrow 218. The device 100 then advances the sheet 128 downwards along the duplex reversal tray 216, per the arrow 220, after having drawn the media sheet 128 back in at the duplex reversal point 160.

In both FIGS. 2A and 2B, the printing device 100 advanceably flips the media sheet 128 over per the arrow 212, and advances the sheet in the direction indicated by the arrow 214. The duplex printing path 150 then becomes the same as the simplex printing path 130. The device 100 flips the sheet 128 over per the arrow 202, and advances the media sheet 128 past the print engine 106, as indicated by the arrow 204.

The print engine 106 can print on the side of the media sheet 128 incident to the engine 106 as the sheet 128 advances past. This is the side opposite the side of the media sheet 128 that the engine 106 printed on when the sheet 128 advanced along the simplex printing path 130. The printing device 100 advanceably flips the media sheet 128 over, per the arrow 206, and advances the sheet 128 in the direction indicated by the arrow 208 before putting the media sheet 128 onto the output tray 104.

The duplex printing path 150 of FIGS. 2A and 2B can be leveraged to receive manual insertion of a media sheet 128 at the duplex reversal point 160 in a manual insertion mode, for simplex-printing the sheet 128 without having to advance the media sheet 128 through the simplex printing path 130. In FIG. 2A, the output tray 104 serves as an input tray in the manual insertion mode, and may include a control, a media sheet guide ramp, and/or media sheet edge guides as in FIGS. 1A, 1B, and 1C. In FIG. 2B, the duplex reversal tray 216 serves as this input tray, and therefore may include such a control, media sheet guide ramp, and/or media sheet edge guides.

The techniques described in relation to printing devices like those of FIGS. 1A-1C, 2A, and 2B provide for a manual insertion mode in which a media sheet is flipped over prior to simplex-printing. That is, the techniques leverage a duplex printing path in a manual insertion mode such that a media sheet is inserted at a duplex reversal point, flipped over, and then simplex-printed. However, the techniques may be employed in conjunction with printing devices other than those shown in FIGS. 1A-1C, 2A, and 2B.

For example, a printing device may have a duplex printing path in which a media sheet can be manually inserted at a duplex reversal point in a manual insertion mode for simplex-printing without having to flip the sheet. The media sheet therefore travels along a portion of the duplex printing path and not the entirety of the duplex printing path as described above. Such a printing device may have a C- or U-shaped duplex printing path similar to FIGS. 1A-1C, or a S-shaped duplex printing path similar to FIG. 2A or 2B.

For instance, in the context of a printing device having a C- or U-shaped duplex printing path similar to FIGS. 1A-1C, a media sheet may be manually insertable at the duplex reversal point 160 of FIG. 1C and drawn into the printing device 100. Once the lagging edge of the sheet has advanced past the print engine 106, the media sheet is reversed in direction back out the device 100. As the sheet advances past the print engine 106, the engine 106 prints on the sheet. The media sheet is thus simplex-printed after manual insertion at the duplex reversal point 160, without having to be flipped over.

Similarly, in the context of a printing device having an S-shaped duplex printing path similar to FIG. 2A or 2B, a media sheet may be manually insertable at the duplex reversal point 160 of FIG. 2A or 2B and drawn into the printing device 100. Rather than advancing along the part of the duplex printing path 150 indicated by the arrow 212, the sheet may advance along the parts of the path 150 indicated by the arrows 206 and 204, but in the opposite direction. Once the lagging edge of the media sheet has advanced past the print engine 106, the sheet reverses and advances in the direction of the arrows 204, 206, and 208. The sheet is thus simplex-printed after manual insertion at the duplex reversal point 160, without having to be flipped over.

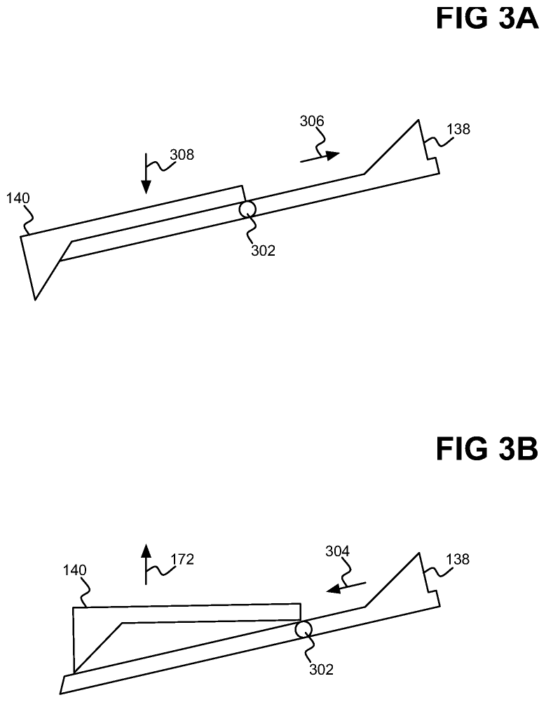

FIGS. 3A and 3B show an example of the control 138 and the media guide ramp 140 in detail. FIG. 3A shows the guide ramp 140 in the unused, recessed position. FIG. 3B shows the guide ramp 140 in the used, extended position. The guide ramp 140 is rotatable about a pivot point 302. FIGS. 3A and 3B show the control 138 as a triangular button, but the button may instead be rectangular or another shape.

To switch the media guide ramp 140 from the recessed position of FIG. 3A to the extended position of FIG. 3B, the control 138 is pushed in, as indicated by arrow 304 in FIG. 3B. The control 138 engages the guide ramp 140, pushing the ramp 140 up per the arrow 172 in FIG. 3B as the guide ramp 140 rotates about the pivot point 302. To switch the guide ramp 140 from the extended position of FIG. 3B to the recessed position of FIG. 3A, the control 138 is pulled out, as indicated by arrow 306 in FIG. 3A. The control 138 no longer engages the guide ramp 140, permitting the ramp 140 to freely rotate about the pivot point 302 to move downward per arrow 308 in FIG. 3A.

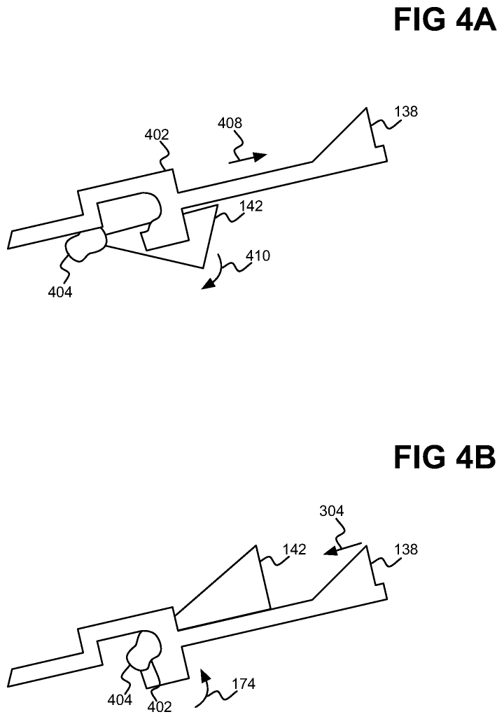

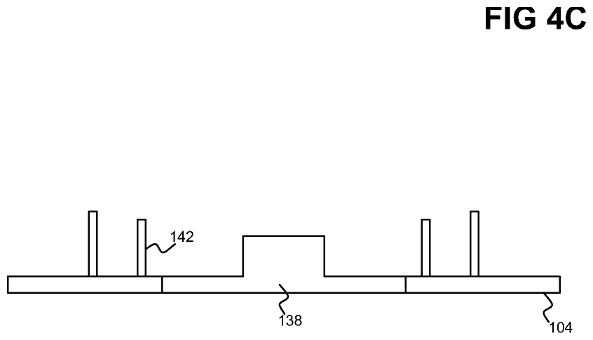

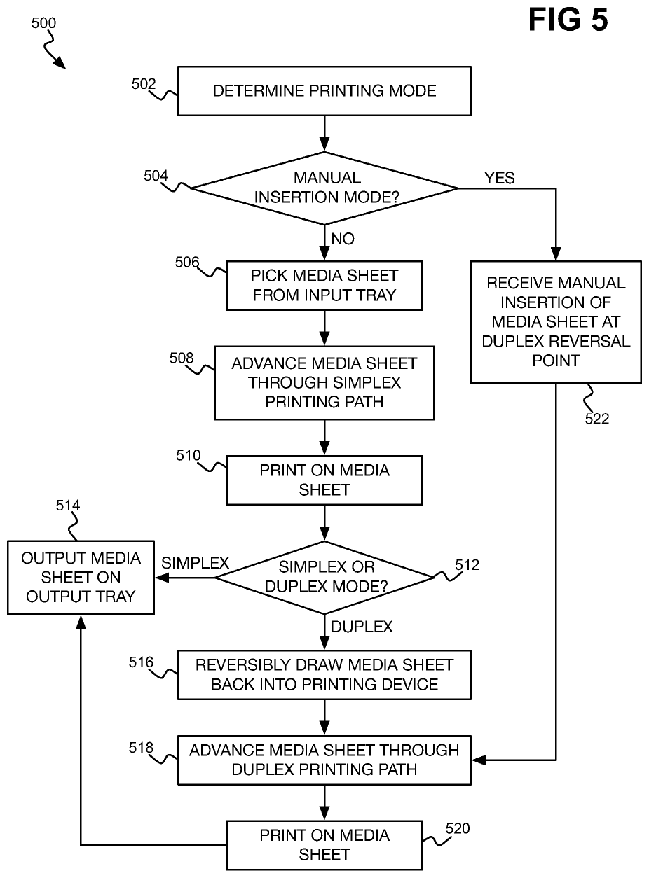

FIGS. 4A, 4B, and 4C show an example of the control 138 and the media sheet edge guides 142 in detail. As noted above, the edge guides 142 assist lateral positioning of the media sheet 128 during manual media sheet insertion, permitting accurate media sheet insertion between the guides 142. FIG. 4A shows the edge guides 142 in the unused, recessed position. FIG. 4B shows the edge guides 142 in the used, extended position. Each media sheet edge guide 142 includes a pivot point 404, and the control 138 includes a cam 402 matching the pivot point 404.

To switch the media sheet edge guides 142 from the recessed position of FIG. 4A to the extended position of FIG. 4B, the control 138 is pushed in, as indicated by the arrow 314 in FIG. 4B. The cam 402 of the control 138 engages the edge guides 142 at their pivot points 404, rotating the guides 142 upwards about the pivot points 404 per the arrow 174 in FIG. 4B. The cam 402 and the pivot points 404 are configured so that the edge guides 142 can be individually pushed down back to the recessed position while the control 138 remains pushed in.

Pulling out the control 138, as indicated by arrow 408 in FIG. 4A, also switches the edge guides 142 from the extended position of FIG. 4B to the recessed position of FIG. 4A. As the cam 402 releases the edge guides 142, the cam 402 causes the guides 142 to rotate downwards about their pivot points 404 per the arrow 410 in FIG. 4A. Whereas the edge guides 142 can be individually pushed back to the recessed position while the control 138 remains pushed in as in FIG. 4B, pulling out the control 138 switches every guide 142 in the extended position to the recessed position of FIG. 4A.

FIG. 4C shows a view of the control 138 and the media edge guides 142 along the output tray 104, in the used, extended position, looking inwards in the direction of the arrow 304 of FIG. 4B. In the example of FIG. 4C, there are two pairs of edge guides 142: an inner edge guide pair and an outer edge guide pair. The space between each pair of edge guides 142 corresponds to a different media size. Because the edge guides 142 can be individually pushed down to their recessed position while the control 138 remains pushed in, the inner guide pair can be pushed down when inserting a media sheet having a size corresponding to the outer guide pair. The inner guide pair can be smaller in height than the outer guide pair, as shown in FIG. 4C, so that when inserting a media sheet having a size corresponding to the outer guide pair, the sheet rests on the inner pair while still being able to be guided by the outer pair.

FIG. 5 shows an example method 500 for printing using a printing device having a duplex printing path with a duplex reversal point at which a media sheet can be manually inserted into the printing device. The method 500 can be performed by a printing device controlling a print engine, rollers, and other components of the device. The method 500 may be implemented as code stored on a non-transitory computer-readable data storage medium and executable by the printing device.

The controller determines the printing mode of the printing device (502). The printing device may operate in a simplex mode, a duplex mode, or a manual insertion mode. The user may specify the simplex mode or the duplex mode at the printing device or at a host computing device, such as a computer, to which the printing device is communicatively connected. The user may specify the manual insertion mode by pushing in a control as has been described, which the controller may detect and that correspondingly causes the controller the printing device to operate in the manual insertion mode.

If the printing mode is the simplex mode or the duplex mode (504), then the controller controls the rollers of the printing device to pick a media sheet from an input tray of the device (506). The controller causes the rollers to advance the media sheet through a simplex printing path of the device (508), beginning at a simplex entry point of the simplex printing path. As the media sheet advances along the simplex printing path, the controller causes a print engine of the printing device to print on a side of the sheet (510).

If the printing mode is the simplex mode (512), then the controller causes the rollers to output the simplex-printed media sheet on an output tray of the printing device (514). However, if the printing mode is the duplex mode (512), then the controller causes the rollers to reversibly draw the media sheet back in at a duplex reversal point (516). The controller causes the rollers to advance the media sheet through a duplex printing path of the printing device (518).

As the media sheet advances along the duplex printing path, the controller causes the print engine to print on the media sheet (520). The engine prints on the side of the sheet facing down when it was reversibly drawn in at the duplex reversal point. In the duplex mode, this is the side opposite the side that the engine printed on while the media sheet previously had advanced along the simplex printing path. The controller finally causes the rollers to output the duplex-printed media sheet on the output tray (514).

If the printing mode is the manual insertion mode (504), then the controller receives manual insertion of a media sheet at the duplex reversal point of the duplex printing path (522). As in the duplex mode, the controller causes the rollers to advance the media sheet through the duplex printing path (518), and causes the print engine to print on the sheet as it advances along the duplex printing path (520). The controller finally causes the rollers to output the media sheet on the output tray (514).

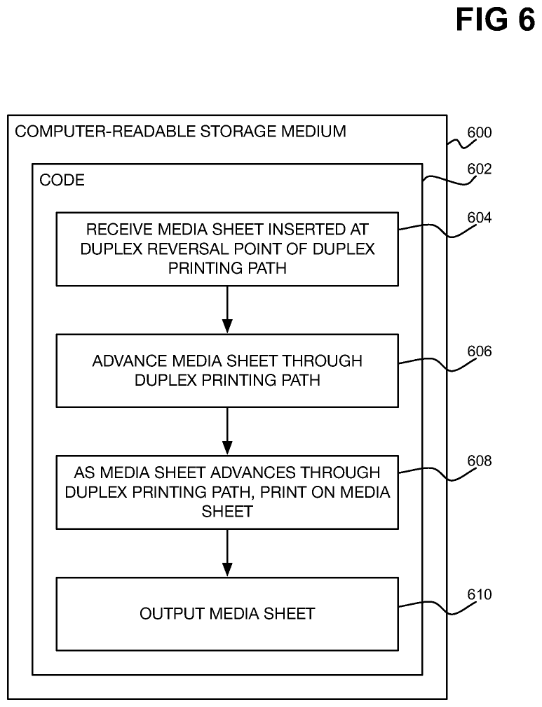

FIG. 6 shows an example non-transitory computer-readable data storage medium 600. The computer-readable data storage medium 600 stores code 602 executable by a printing device. The printing device executes the code 602 to receive manual insertion of a media sheet at a duplex reversal point of a duplex printing path of the printing device (604), and advance the manually inserted media sheet through the duplex printing path (606). The printing device executes the code 602 to print on the media sheet as the sheet advances through the duplex printing path (608), and output the printed sheet from the printing device (610).

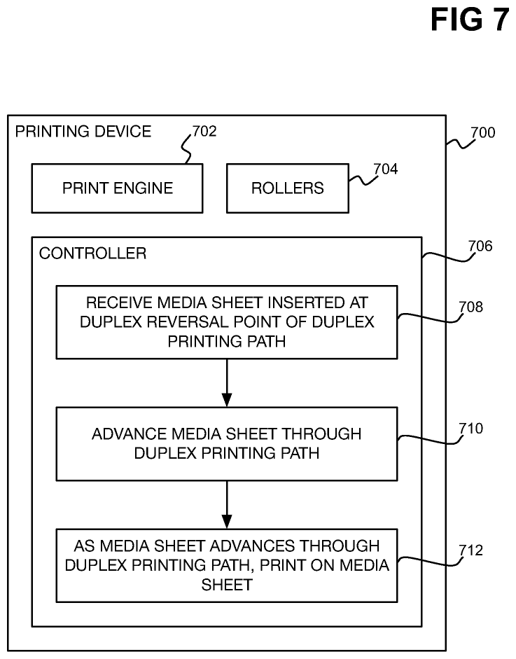

FIG. 7 shows an example printing device 700. The printing device 700 includes a print engine 702, rollers 704, and a controller 706. The rollers 704 define a duplex printing path having a duplex reversal point.

The controller 706 is implemented at least in hardware. For example, the controller 706 may be or include an application-specific integrated circuit (ASIC), which is a type of special-purpose processor programmed in accordance with program code, such that the ASIC constitutes both the processor and the data storage medium. The controller 706 may be or include a general-purpose processor that executes program code stored on a separate data storage medium like a semiconductor integrated circuit (IC) or a magnetic storage medium.

The controller 706 controls the rollers 704 to receive a media sheet manually inserted at the duplex reversal point (708). The controller 706 controls the rollers 704 to advance the manually inserted media sheet through the duplex printing path (710). The controller 706 controls the print engine 702 to print on the media sheet as the sheet advances through the duplex printing path (712).

Techniques have been described herein for leveraging a duplex printing path of a printing device having automatic duplex printing capability to also receive manual insertion of media sheets at a duplex reversal point of the duplex printing path. A media sheet having a different type, including a different size, than the media sheets loaded in an input tray of the printing device can be more easily loaded into the device for printing. The media sheets in the input tray do not have to be disturbed, nor does the printing device have to include an additional input tray.

We claim:

1. A non-transitory computer-readable data storage medium storing program code executable by a printing device to:
receive manual insertion of a media sheet at a duplex reversal point of a duplex printing path of the printing device;
advance the manually inserted media sheet through the duplex printing path;
as the media sheet advances through the duplex printing path, print on the media sheet; and
output the printed media sheet from the printing device.

2. The non-transitory computer-readable data storage medium of claim 1, wherein the duplex reversal point is a point at which media sheets to be duplex-printed are reversibly drawn back into the printing device for advancement through the duplex printing path for second-side printing after having been first-side printed during advancement through a simplex printing path.

3. The non-transitory computer-readable data storage medium of claim 1, wherein the duplex printing path is leverage to receive manual insertion of the media sheet at the duplex reversal point for simplex-printing the media sheet without the media sheet having to advance through a simplex printing path of the printing device.

4. The non-transitory computer-readable data storage medium of claim 1, wherein the media sheet is simplex-printed and is a first media sheet, and wherein the program code is executable by the control to cause the printing device to further:
advance a second media sheet positioned at a simplex entry point of a simplex printing path of the printing device;
as the second media sheet advances through the simplex printing path, print on a first side of the second media sheet;
reversibly draw the second media sheet back into the printing device at the duplex reversal point and advance the second media sheet through the duplex printing path;
as the second media sheet advances through the duplex printing path, print on a second side of the second media sheet to duplex-print the second media sheet; and
outputting the duplex-printed second media sheet from the printing device.

5. The non-transitory computer-readable data storage medium of claim 1, wherein the media sheet is simplex-printed and is a first media sheet, and wherein the program code is executable by the printing device to further:
advance a second media sheet positioned at the simplex entry point of the simplex printing path of the printing device;
as the second media sheet advances through the simplex printing path, print on the second media sheet to simplex-print the second media sheet; and
output the simplex-printed second media sheet from the printing device.

6. A printing device comprising:
a print engine;
a plurality of rollers defining a duplex printing path having a duplex reversal point; and
a controller to:
control the rollers to receive a media sheet manually inserted at the duplex reversal point and advance the manually inserted media sheet through the duplex printing path; and
control the print engine to print on the media sheet as the media sheet advances through the duplex printing path.

7. The printing device of claim 6, wherein the duplex reversal point of the printing path is a point at which media sheets to be duplex-printed are reversibly drawn back into the printing device for advancement through the duplex printing path for second-side printing after having been first-side printed during advancement through a simplex printing path.

8. The printing device of claim 6, wherein the duplex printing path is leverage to receive manual insertion of the media sheet at the duplex reversal point for simplex-printing the media sheet without the media sheet having to advance through a simplex printing path of the printing device.

9. The printing device of claim 6, wherein the controller is to control the rollers to receive and advance the media sheet through the duplex printing path and cause the print engine to print on the media sheet as the media sheet advances through the duplex printing path in a manual insertion mode,
and wherein the media sheet is a first media sheet, the rollers further define a simplex printing path having a simplex entry point, and the controller is further to:
control the rollers to advance a second media sheet positioned at the simplex entry point through the simplex printing path; and
control the print engine to print on a first side of the second media sheet as the second media sheet advances through the simplex printing path.

10. The printing device of claim 9, wherein in a simplex mode the controller is further to:
control the rollers to output the second media sheet from the printing device after the print engine has printed on the first side of the second media sheet.

11. The printing device of claim 10, wherein in a duplex mode the controller is further to:
control the rollers to reversibly draw the second media sheet back into the printing device after the print engine has printed on the first side of the second media sheet, and advance the second media sheet through the duplex printing path;
control the print engine to print on a second side of the second media sheet as the second media sheet advances through the duplex printing path; and
control the rollers to output the second media sheet from the printing device after the print engine has printed on the second side of the second media sheet.

12. The printing device of claim 6, wherein the controller is to cause the rollers to receive and advance the media sheet through the duplex printing path and cause the print engine to print on the media sheet as the media sheet advances through the duplex printing path in a manual insertion mode, the printing device further comprising:
a control to cause the controller to operate in the manual insertion mode.

13. The printing device of claim 12, further comprising:
a media sheet guide ramp switchably positionable in the manual insertion mode to a used configuration in which the media ramp guides the manually inserted media to the duplex reversal point.

14. The printing device of claim 13, wherein the rollers comprise a reversibly rotatable roller at the duplex reversal point, the reversibly rotatable roller rotatable in a rotational direction to receive the media sheet manually inserted at the duplex reversal point and rotatable in an opposite rotational direction as the print engine prints on the media sheet,
wherein in the used configuration the media sheet guide ramp is tangential to the reversibly rotatable roller at the duplex reversal point.

15. The printing device of claim 13, further comprising:
an output tray onto which the rollers output the media sheet once the print engine has printed on the media sheet; and
a plurality of media sheet edge guides switchably positionable in the manual insertion mode to a used configuration in which the media sheet edge guides assist lateral positioning of the media sheet during manual insertion at the duplex reversal point,
wherein the output tray also serves as an input tray into the manual insertion mode.
